(19) United States
(12) Patent Application Publication
(10) Pub. No.: US 2004/0212254 A1
(43) Pub. Date: Oct. 28, 2004

(54) Tube geometry motor for electromagnetic transducer

(76) Inventor: Enrique M. Stiles, Imperial Beach, CA (US)

Correspondence Address: RICHARD C. CALDERWOOD, 2775 NW 126TH AVE, PORTLAND, OR, 97229-8381, US

(21) Appl. No.: 10/423,726

(22) Filed: Apr. 25, 2003

(51) Int. Cl. H02K 41/00; H04R 1/00; H04R 9/06

(52) U.S. Cl. 310/12; 381/421; 381/412

(57) ABSTRACT

An electromagnetic transducer such as an audio speaker, having a tube geometry motor which is not axisymmetric. The tube geometry motor includes a tubular yoke of soft magnetic material. The tube includes an air gap hole through a wall of the tube. A pole piece extends through the air gap hole to define the magnetic air gap between the tube wall and the pole piece. A hard magnet is coupled to the tube. In some embodiments, the pole piece is coupled to a back plate inside the tube, which in turn is coupled to the hard magnet. A diaphragm assembly is coupled to the outer side of the tube. The axis of movement of the diaphragm assembly and the extruded axis of the tube motor are perpendicular. Different models of the transducer motor can be fashioned by increasing the magnetic flux over the magnetic air gap, without having to make the motor wider or deeper, and without requiring new tooling for the tube, simply by making the motor longer and longer along the extruded axis.

### RELATED APPLICATIONS

This application is related to a co-pending application entitled “Push-Push Multiple Magnetic Air Gap Transducer” Ser. No. 10/289,109 filed Nov. 4, 2002, a co-pending application entitled “Electromagnetic Transducer Having a Low Reluctance Return Path” Ser. No. 10/289,080 filed Nov. 4, 2002, and a co-pending application entitled “Electromagnetic Transducer Having a Hybrid Internal/External Magnet Motor Geometry” Ser. No. 10/337,035 filed Jan. 6, 2003, all by this inventor.

### BACKGROUND OF THE INVENTION

1. Technical Field of the Invention

This invention relates generally to electromagnetic transducers such as audio speakers, and more specifically to a motor structure for such, having a tubular geometry rather than an axisymmetric geometry.

2. Background Art

FIG. 1 illustrates a conventional speaker 10 with an external magnet geometry motor structure 12 driving its diaphragm assembly 14. The motor structure includes a pole plate 16 style yoke, made of soft magnetic material and including a back plate 18 and a pole piece 20 that are either magnetically coupled or of integral construction. The pole plate may optionally include a ventilation hole 22 for depressurizing the diaphragm assembly. One or more external ring hard magnets 24 are magnetically coupled to the back plate. A top plate 26 of soft magnetic material is magnetically coupled to the hard magnets. A magnetic air gap 28 is formed between the top plate and the pole piece.

The diaphragm assembly includes a basket 30 which is mechanically coupled to the motor assembly to support the other, moving parts of the diaphragm assembly. A diaphragm 32, sometimes referred to as a cone, is coupled to the basket by a flexible suspension component known as a surround 34. A voice coil former or bobbin 36 is mechanically coupled to the diaphragm, and is coupled to the basket by a flexible suspension component known as a spider 38. The surround and spider allow the bobbin and diaphragm to move axially with respect to the motor structure, but prevent, as much as possible, their lateral movement and rocking. An electrically conductive voice coil 40 is wound around and mechanically coupled to the bobbin, and is disposed within the magnetic air gap of the motor structure. A dust cap 42 is coupled to the diaphragm to seal the open end of the bobbin.

FIG. 2 illustrates a conventional speaker 50 with an internal magnet geometry motor structure 52 driving the diaphragm assembly 14. The motor structure includes a yoke or cup 54 of soft magnetic material. One or more internal hard magnets 56 are magnetically coupled to the cup, and an internal top plate 58 of soft magnetic material is magnetically coupled to the hard magnets, forming a magnetic air gap 60 between the top plate and the cup. The motor structure may be ventilated, as shown, or it may be unventilated and have disc magnets and a disc top plate, rather than the ring configuration shown.

Both the external magnet geometry motor structure of FIG. 1, and the internal magnet geometry motor structure of FIG. 2 are axisymmetric, meaning that they have a generally circular shape when viewed along their motors' respective axes. In order to use larger magnets, it has previously been necessary to grow the motor structure in all radial directions, by making the diameter larger.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 shows a conventional external magnet geometry speaker according to the prior art.

FIG. 2 shows a conventional internal magnet geometry speaker according to the prior art.

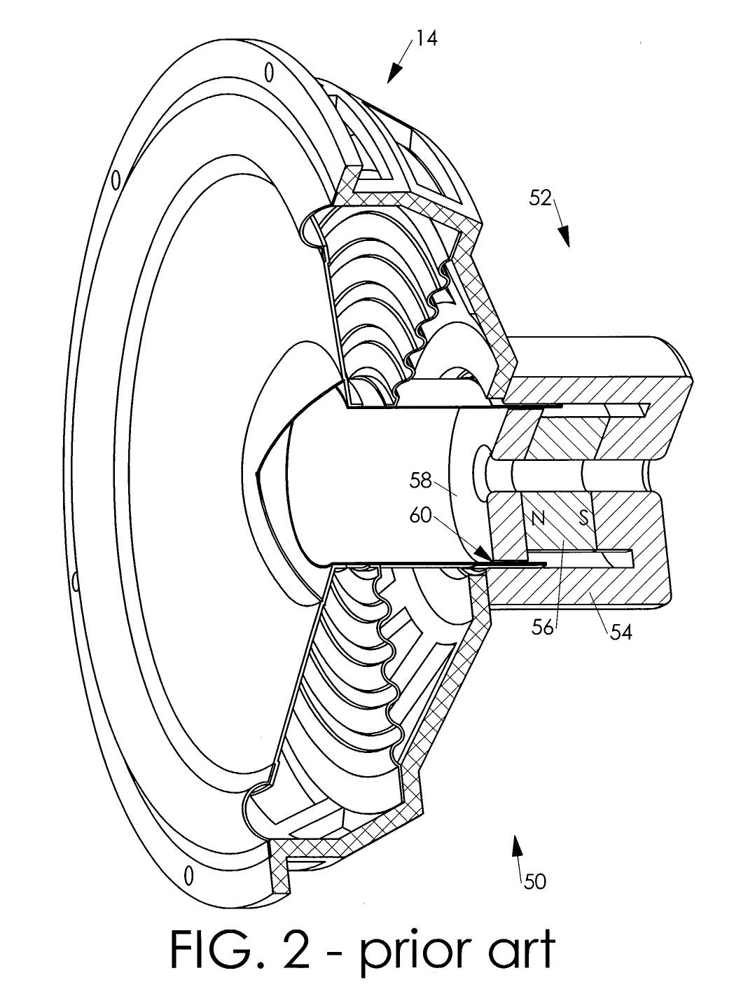

FIG. 3 shows a speaker having a tube geometry motor structure according to one embodiment of this invention.

FIG. 4 shows a speaker having a greatly elongated tube geometry motor according to another embodiment of this invention.

FIG. 5 shows a speaker having a v-shaped tube geometry motor according to another embodiment of this invention.

FIG. 6 shows a speaker having a cylindrical tube geometry motor according to another embodiment of this invention.

FIG. 7 shows a speaker having a tube geometry motor with a magnetic air gap sleeve according to another embodiment of this invention.

FIG. 8 shows a speaker having a tube geometry motor with an external second magnetic air gap according to another embodiment of this invention.

FIG. 9 shows a speaker having a tube geometry motor with an internal second magnetic air gap according to another embodiment of this invention.

FIG. 10 shows a speaker having a tube geometry motor with a channel component providing a second magnetic air gap.

FIG. 11 shows a tube geometry motor structure in which the tube includes two components butted end-to-end and coupled together by mating channel components inside the tube.

FIG. 12 shows a tube geometry motor structure in which the mating channel components are external to the tube.

FIG. 13 shows a speaker having a hybrid tube geometry motor structure.

FIG. 14 shows one embodiment of a push-pull tube motor structure.

### DETAILED DESCRIPTION

The invention may be utilized in a variety of magnetic transducer applications, including but not limited to audio speakers, microphones, mechanical position sensors, actuators, and the like. For the sake of convenience, the invention will be described with reference to audio speaker embodiments, but this should be considered illustrative and not limiting.

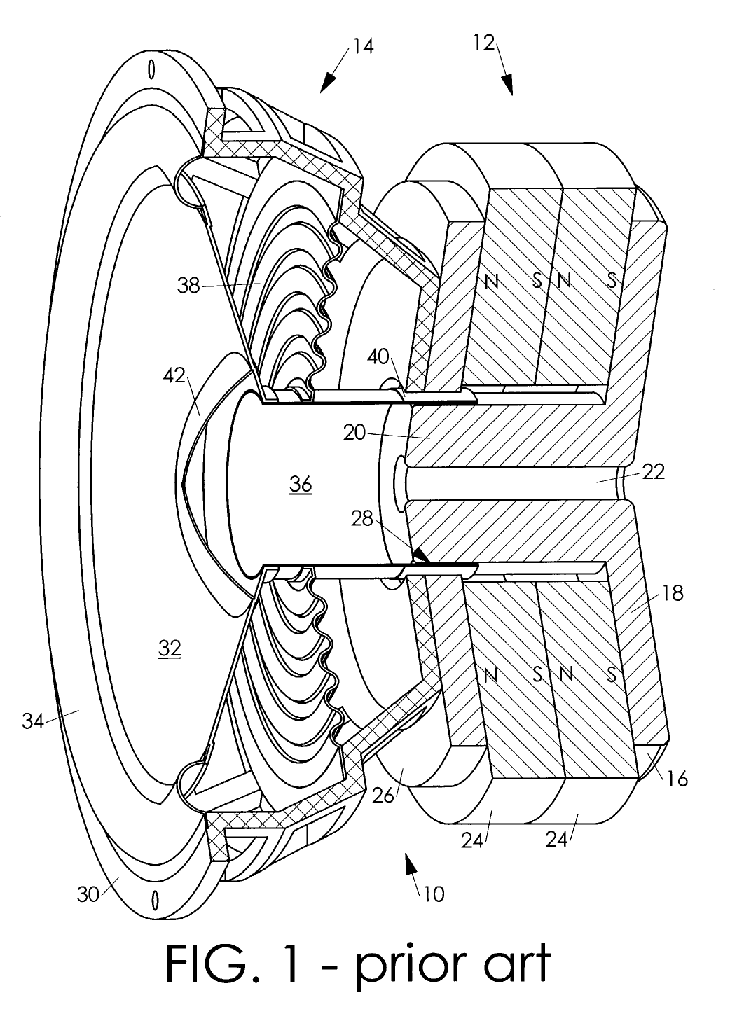

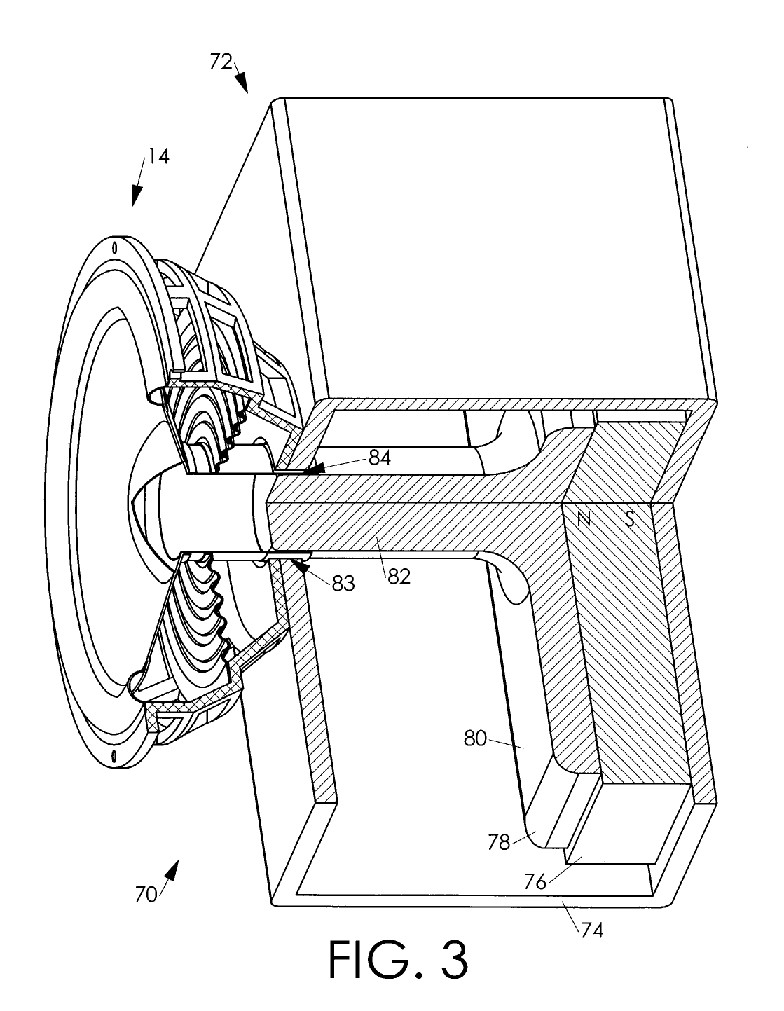

FIG. 3 illustrates one embodiment of a speaker 70 having a tube geometry motor 72 driving a diaphragm assembly 14. The tube geometry motor is not axisymmetric. It includes a tube 74 which may have various aspect ratios and which is formed of soft magnetic material. Its cross-section may be substantially square, as shown, or it may have any of a wide variety of other shapes. The tube has an extruded axis, roughly vertical on the page as shown, along which the tube may be extruded during one mode of manufacturing. One or more hard magnets 76 are magnetically coupled to an interior surface of the tube. The hard magnet has a south pole face and a north pole face, through which the magnetic flux lines enter and exit the hard magnet. If there are plural hard magnets, they may be stacked (as shown in FIG. 1) to build up a thicker overall magnet, or they may be butted end-to-end to, in effect, create one larger overall magnet having increased pole face surface area. A pole plate 78 is magnetically coupled to the hard magnets. The pole plate advantageously includes a back plate 80 which has a back face which is magnetically coupled to a pole face of the hard magnets, and a pole piece 82 which extends through an air gap hole 83 in the opposite wall of the tube to define a magnetic air gap 84.

The pole piece and the back plate may be distinct components, or they may be a monolithic pole plate. In one such embodiment, the back plate has a threaded hole and the pole piece has a threaded end which engages the hole. Manufacturing of such a pole piece may be easier if there is no fillet transition from the pole piece to the back plate. One advantage of this two-component embodiment is that the back plate can be inserted into the tube, and the pole piece can then be inserted through the tube's magnetic air gap hole and coupled to the back plate, enabling the use of a pole plate whose overall height is too great to fit within the tube as a pre-assembled or monolithic pole plate.

Ideally, there should be some space between the sides of the magnets and the adjacent walls of the tube, to greatly reduce the tendency of magnetic flux to jump directly from the hard magnets to those walls, rather than traveling into the pole plate and over the magnetic air gap. For ease of assembly, the overall height of a monolithic pole plate, from the back surface which mates with the magnets to the end of the pole piece, should be shorter than the internal dimension of the tube, allowing the pole plate to be slid into position through an end of the tube, then moved (to the left in FIG. 3) far enough to allow the hard magnets to be slid in between the back plate and the tube's inner wall. Alternatively, the tube may be split into two components at the air gap hole, to allow for assembly without the pole plate having to fit through the tube. In some applications, it may be advantageous for the pole piece to extend slightly beyond the outer surface of the tube, after assembly, to maximize the symmetry of the magnetic flux fringing fields at the two ends of the magnetic air gap.

The open ends of the tube may be covered with magnetic shields (not shown) to contain stray magnetic flux. The shields may advantageously be vented to permit airflow to cool and depressurize the motor structure.

The tube motor structure offers significant cooling advantages. The long tube of the motor acts as a large heatsink with lots of exposed surface area. The open-ended tube, even with vented shields, enables airflow through the heart of the motor structure to a degree significantly greater than in conventional motor structures. Airflow through the tube may be enhanced by adding a fan or other forced air mechanism, especially in applications in which the ambient noise of such mechanisms are not unacceptable. In applications in which the noise might be unacceptable, cooling of the tube motor structure can be improved simply by placing the tube in a vertical orientation, in which it will act as a thermal convection chimney; as the voice coil heats the air inside the motor, the heated air will rise out the top of the tube, drawing cool air in the bottom end of the tube.

The hard magnet(s) have a pole face whose surface area is larger than the area of the air gap hole through which the pole piece extends. In some embodiments, the pole face surface area may be twice that of the air gap hole, or four, eight, or sixteen times, or any other amount. In some embodiments, the hard magnet (or the individual hard magnets of a conglomerate magnet) are too large to fit through the air gap hole.

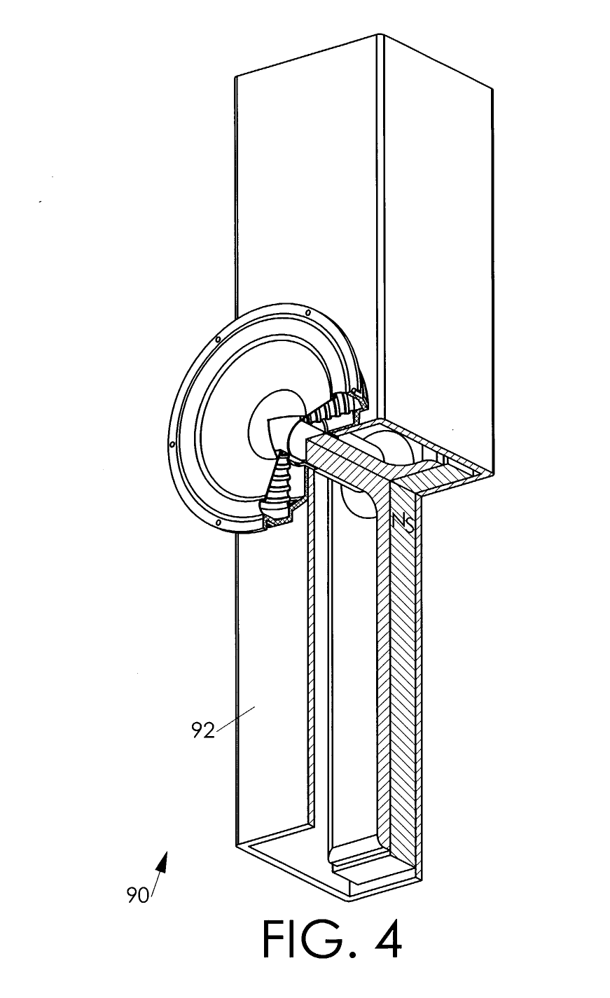

FIG. 4 illustrates another embodiment of a speaker 90 having a tube geometry motor 92 with a greatly elongated tube assembly. One advantage of this invention is that it allows the designer to increase the magnetic flux density over the magnetic air gap without increasing the size of the motor structure in all radial directions. If more magnetic flux is needed, the designer can simply make the tube, magnets, and pole plate longer.

One significant advantage offered by this invention is that it enables the manufacturer to create two motors of different magnetic strengths, without significant investment in a second set of tooling. For example, a second, stronger motor can be manufactured simply by cutting a longer tube and by cutting a longer magnet or even using two copies of the same magnet placed end to end within the longer tube.

One advantage which this offers is that the speaker can be externally mounted into a cabinet (or car door, or wall, etc.) through a hole which is smaller than the largest dimension of the motor; one end of the motor can be poked through the hole, and slid inward until the other end of the motor passes through the hole. This is not possible with axisymmetric motors, just as a circular manhole cover does not fall into its manhole. In some applications, the designer may choose to elongate the motor in only a single direction, rather than uniformly as shown, putting the diaphragm assembly closer to one end of the motor than the other, which will allow an even larger motor structure to fit through a given hole size.

Having an asymmetric motor which is elongated in one direction may be especially advantageous in mounting a speaker into tight quarters. For example, the designer may need to place the speaker near an edge of an automobile door, perhaps with the outer diameter of the speaker frame in very close proximity to the edge of the door, or in close proximity to an internal keep-out zone within the door such as where clearance is needed for moving window mechanisms or the like. If the speaker were limited to a motor which did not extend beyond the perimeter of the basket, it may not be possible to achieve sufficient magnetic flux in the motor. However, by extending the tube motor in a single direction, opposite the door edge or keep-out zone, the magnetic flux of the motor can be raised to the required level, without having the motor's other end cause mounting problems.

In some embodiments, the length of the tube may be at least twice the width of the tube. In other embodiments, the length of the tube may be at least four times the width of the tube. In some embodiments, the length of the tube may be at least twice the width of the basket. In other embodiments, the length of the tube may be at least four times the width of the basket. In other embodiments, the length of the tube may be less than the width of the tube, or less than half the width of the tube.

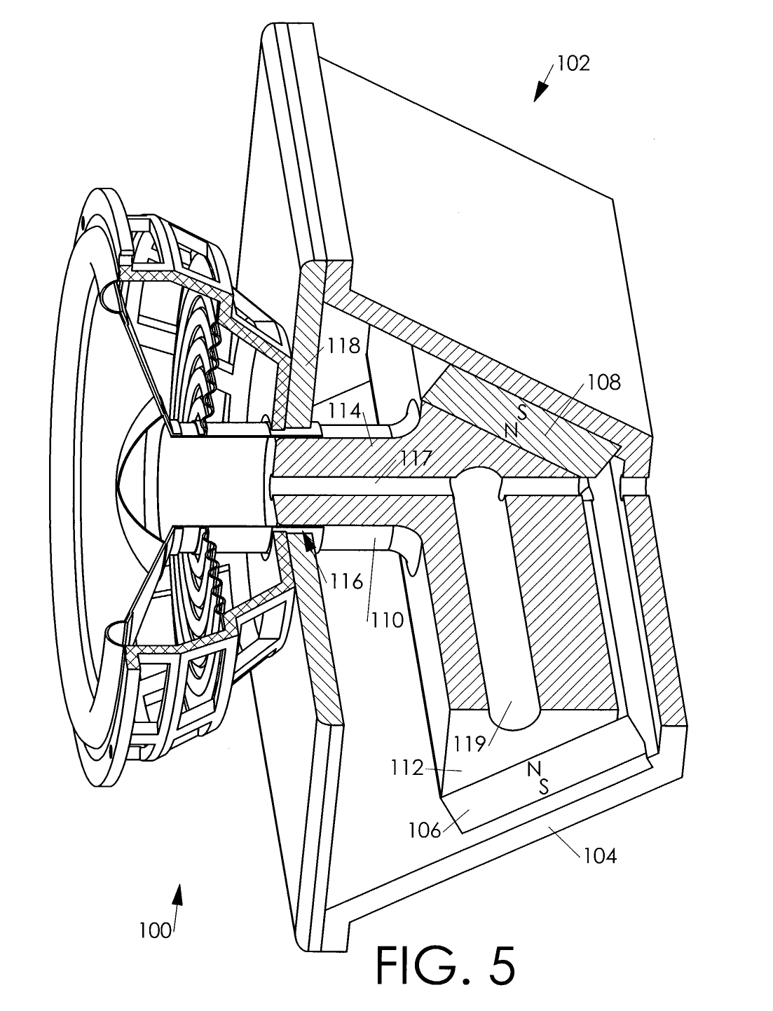

FIG. 5 illustrates another embodiment of a speaker 100 having a non-rectangular tube geometry motor 102. The motor includes a v-shaped tube 104. This tube, as with the other tubes taught in this document, may be of monolithic construction, or they may be formed by magnetically coupling separate components together, as shown here. One or more (and preferably two) hard magnets 106, 108 are magnetically coupled inside the v-shaped tube. A pole plate 110 is magnetically coupled to the hard magnets. Advantageously, the pole plate may include a wedge-shaped back plate 112 which has an exterior angle substantially the same as an interior angle of the v-shaped tube, so the back plate mates tightly with the hard magnets. The pole plate includes a pole piece 114 which defines a magnetic air gap 116 to the top plate 118 portion of the tube.

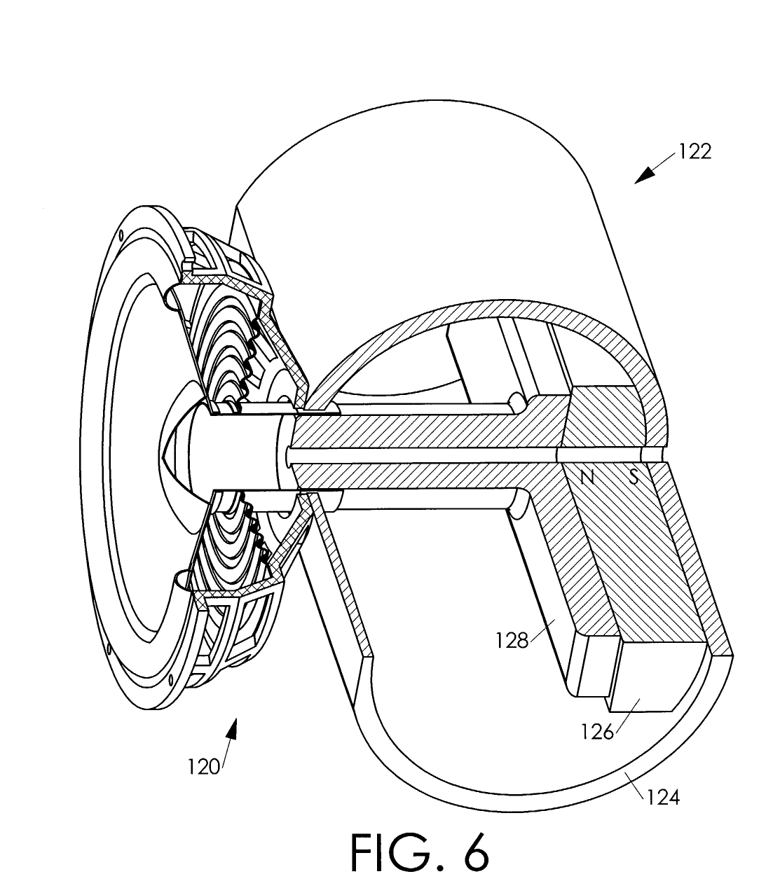

FIG. 6 illustrates another embodiment of a speaker 120 having a non-rectangular tube geometry motor 122. The motor includes a cylindrical tube 124, inside which is magnetically coupled a hard magnet 126. The mating surface of the hard magnet may advantageously be machined to the same shape as the interior surface of the tube; alternatively, a spacer of soft magnetic material and of suitable shape could be located between the tube and the magnet. A pole plate 128 is magnetically coupled to the hard magnet.

One advantage of the cylindrical tube shape is that the exterior surface of the tube is sloped away from the diaphragm assembly and is more aerodynamically shaped, which reduces the back-wave interference or back-pressure, and helps the diaphragm move more easily and reduces or scatters upper frequency reflections so they don't travel back up and through the cone. This feature may be added to the other tube configurations, such as by tapering the diaphragm side of the rectangular tube of FIG. 3.

Disadvantages of this specific configuration are that the magnetic air gap has a non-uniform height and position and that, consequently, it may be difficult to predict or to fine-tune the performance of the motor. Another disadvantage is that the curved internal shape of the back wall requires either a curved magnet or a curved spacer be fashioned. These disadvantages can be avoided by using a tube which has a flattened “racetrack” cross-sectional shape, with a flat back portion where the magnet attaches and a flat top portion where the magnetic air gap is formed and where the basket attaches.

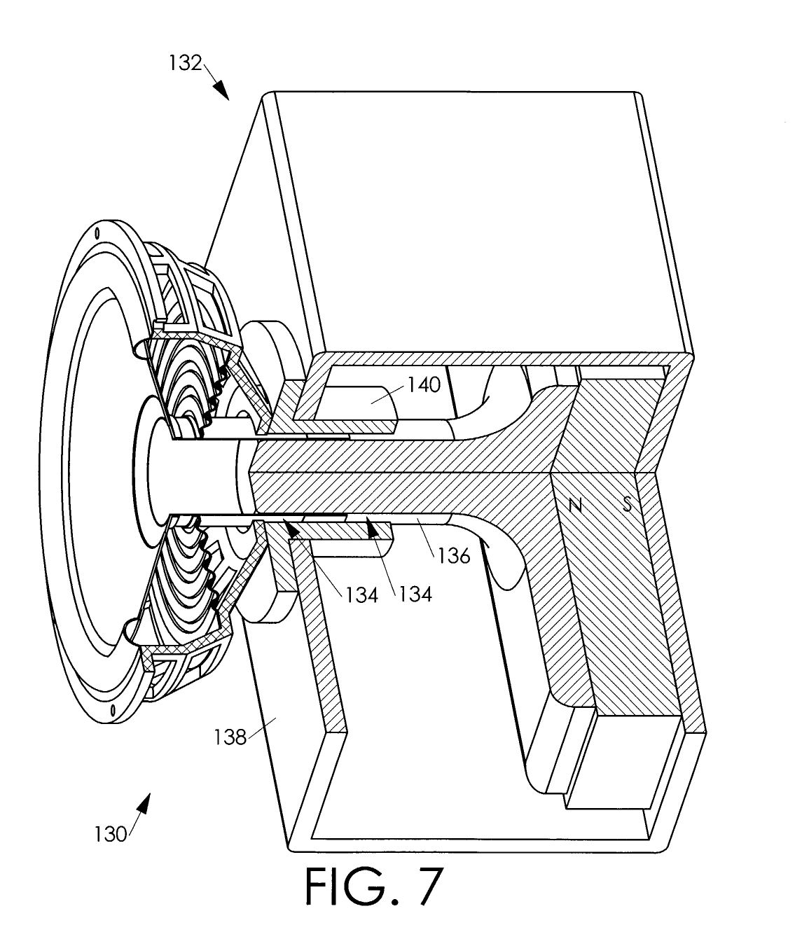

FIG. 7 illustrates another embodiment of a speaker 130 having a tube geometry motor 132. In this motor, the magnetic air gap 134 is not formed directly between the pole piece 136 and the tube 138. Rather, the hole through the tube is made larger, and a sleeve 140 of soft magnetic material is slipped into this larger hole, magnetically and mechanically coupled to the tube. The sleeve may offer a variety of advantages, such as allowing the use of an underhung voice coil which is longer than the thickness of the tube wall. The sleeve may also be useful with tubes which have a shape such that the thickness of the tube is not the same at all radial positions around the hole, such as in the case of a cylindrical tube, especially in the case, as in FIG. 6, where a flat has been machined onto the outer surface of the tube to facilitate better coupling of the diaphragm assembly to the tube. The sleeve can be of any desirable shape, and is not necessarily the generally cylindrical shape shown.

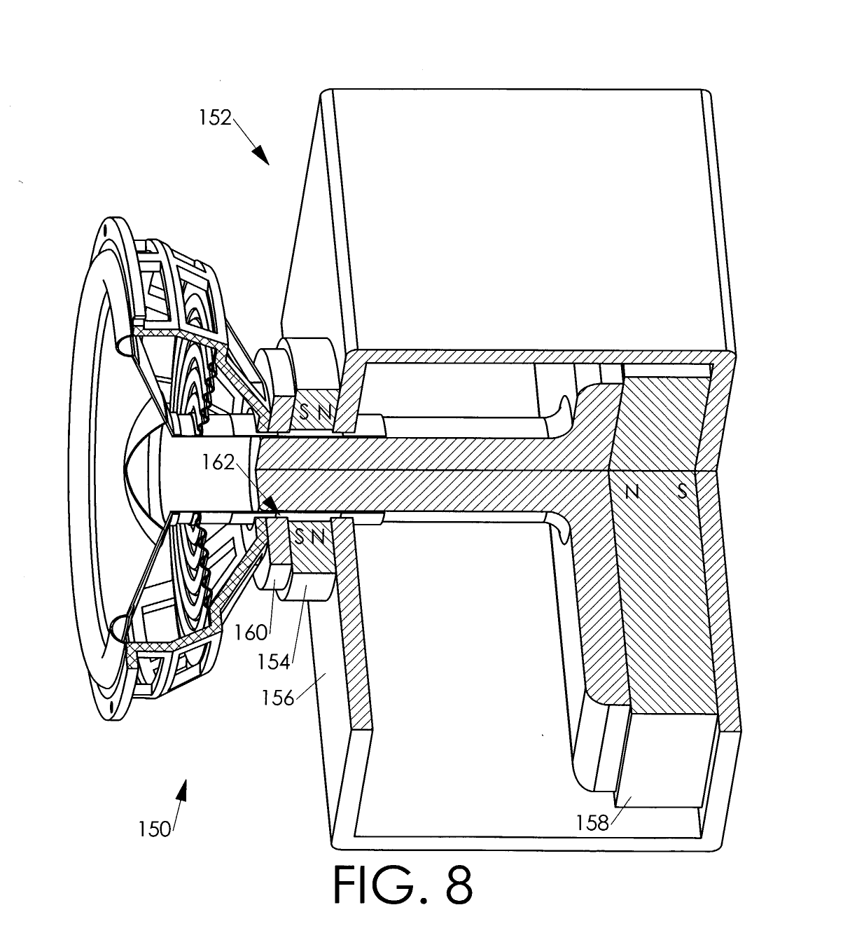

FIG. 8 illustrates another embodiment of a speaker 150 having a tube geometry motor 152 which combines this invention with the “Push-Push Multiple Magnetic Air Gap Transducer” invention. An external hard magnet 154 is magnetically coupled to the exterior surface of the tube 156, around the hole. The external hard magnet may have any desired shape, and is not necessarily confined to being an elongated bar such as the shape of the main magnet 158 inside the tube. An external top plate 160 is magnetically coupled to the external hard magnet, and defines a second magnetic air gap 162 to the pole piece 164. If the internal and external hard magnets have their magnetic poles in opposite orientation, the magnetic flux flows in the same direction over both magnetic air gaps, as shown, and the motor is a “push-push” motor. By correctly sizing the external magnet relative to the other aspects of the geometry, the magnetic flux over the two gaps may be balanced. The voice coil assembly may include two voice coils, as shown, or it may include only a single voice coil. The voice coils may be overhung, underhung, equalhung, or semi-hung as shown.

If the internal and external hard magnets are magnetized in the same orientation, the magnetic flux over the two magnetic air gaps will flow in opposite directions, and the motor will be a “push-pull” motor, in which the voice coils are wound in opposite directions or driven with opposite phase signals.

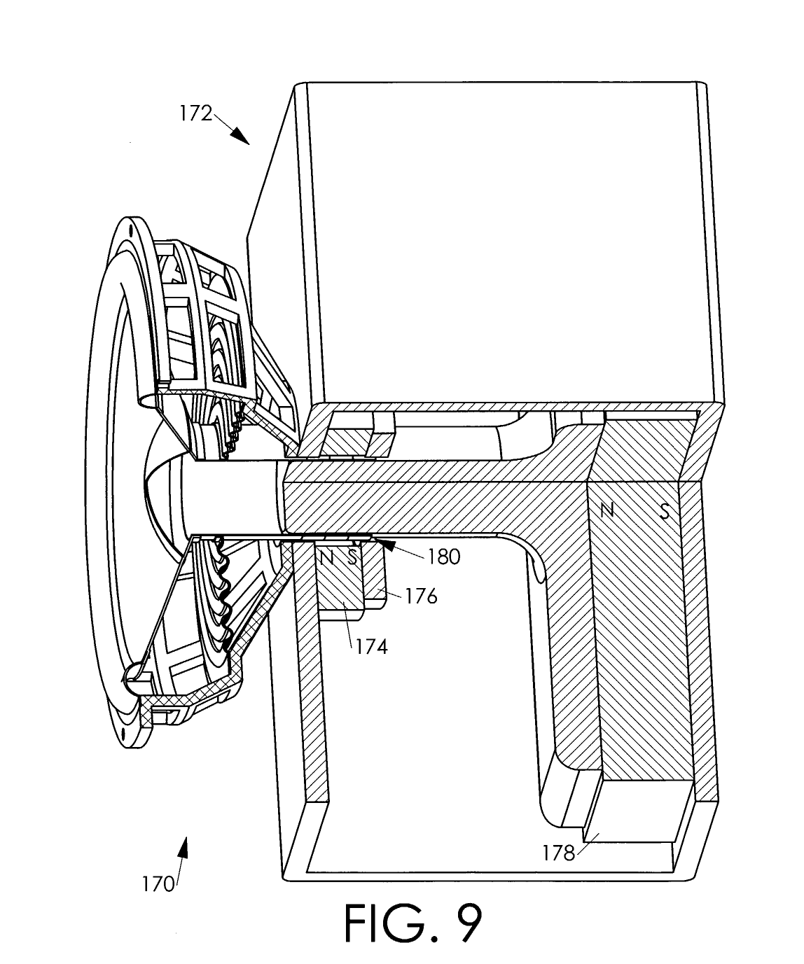

FIG. 9 illustrates another embodiment of a speaker 170 having a tube geometry motor 172 which uses an internal secondary hard or soft magnet 174 and internal top plate 176. One advantage of this configuration over that of FIG. 8 is that the primary hard magnet 178 and the secondary hard magnet may be charged simultaneously and after assembly of the motor, with the motor having a push-push geometry.

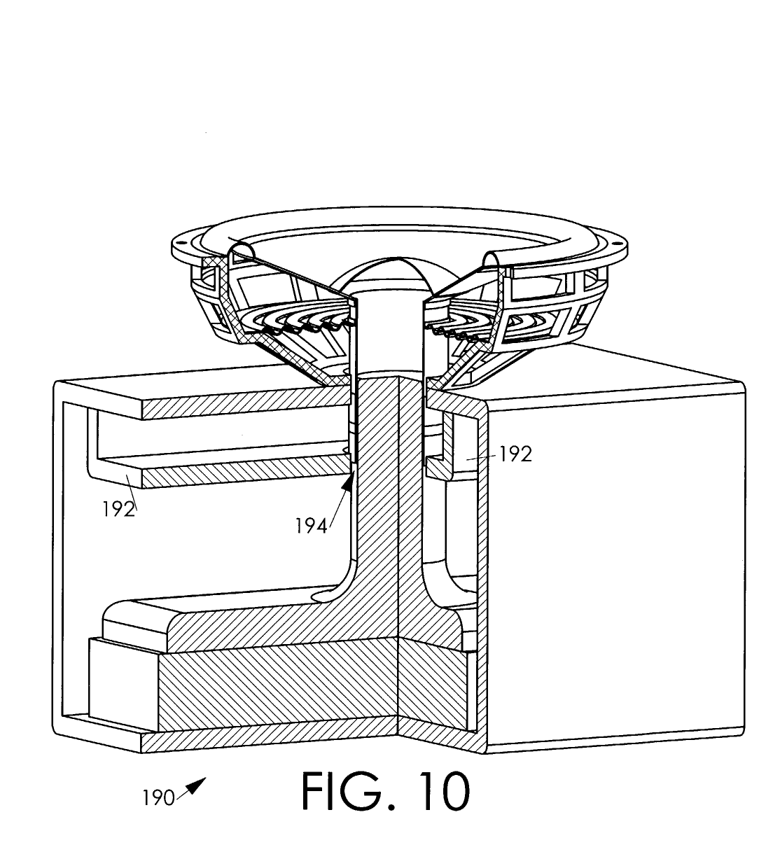

FIG. 10 illustrates another push-push dual-gap geometry tube motor speaker 190. A channel component 192 of soft magnetic material is magnetically coupled inside the motor's tube, and provides a second magnetic air gap 194, without requiring any additional hard or soft magnet. If necessary, magnetic flux over the two respective magnetic air gaps can be balanced by, for example, making the channel component shorter than the tube to decrease magnetic flux over the second magnetic air gap. In one embodiment, the channel component has a rectangular U shape. In other embodiments, it could have other shapes, such as semi-cylindrical, semi-hexagonal, or the like.

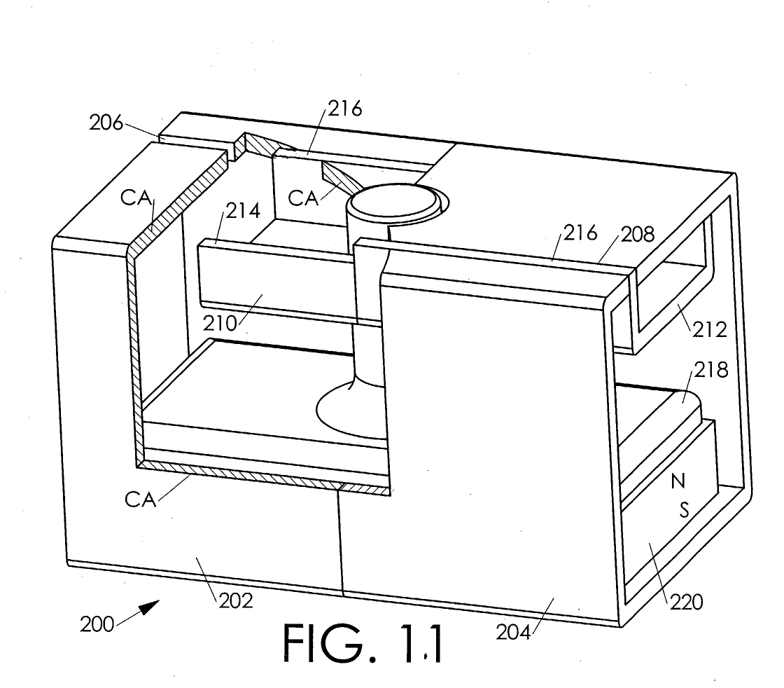

FIG. 11 illustrates another push-push dual-gap geometry tube motor 200. The motor includes a pair of tubes 202, 204 coupled end-to-end into a single tube structure. For ease of illustration, the tube structure is illustrated with a cutaway CA, to provide visibility of internal components. In some embodiments, the tubes are of identical construction, with one of them being reversed 180° as illustrated. Each tube includes a slot or groove 206 (or 208) which extends into the soft magnetic material of the tube from the inside, and may, as illustrated, extend all the way through the tube wall.

A channel component 210 is disposed within the tube structure and may, in some embodiments, serve to mechanically couple the two tubes together. The channel component has a lower wall 212 which defines the second magnetic air gap (not visible). The channel component has a first side wall 214 which butts against the inner wall of the tube structure, and a second side wall 216 which is taller to extend into the slot of the tube structure. In some embodiments, the channel component may be formed as a monolithic structure. In other embodiments, it may be formed in a manner similar to the tube structure, by butting two identical components end-to-end with one of them reversed, as illustrated. The channel component may extend to the end of the tube structure, as illustrated on the right half of the figure, or it may terminate at some point inside the tube structure, as illustrated on the left half of the figure.

This split tube structure enables assembly of motor structures which would not otherwise be possible, such as with a monolithic pole plate 218 having a vertical dimension larger than the internal vertical dimension of the tube (for ease of illustration, the pole piece is not illustrated as being that long). In such cases, the channel component is placed down over the pole piece, the two tube halves are slid from their respective ends over the pole plate and the channel component until they abut one another, and the channel component is raised upward until its taller side walls engage the longitudinal slots of the tubes. The side walls could then be welded or otherwise affixed to their mated tubes. In some embodiments, the slots and the taller portions of the side walls might be tabbed or keyed to prevent longitudinal movement of the tubes once the channel component is engaged. In other embodiments, the tubes could be welded or otherwise coupled together to prevent longitudinal separation. Depending upon the particular needs of the application, the magnet 220 can be positioned either before or after other assembly steps. Other tube geometry motors can be similarly split for assembly, without the need for the channel component.

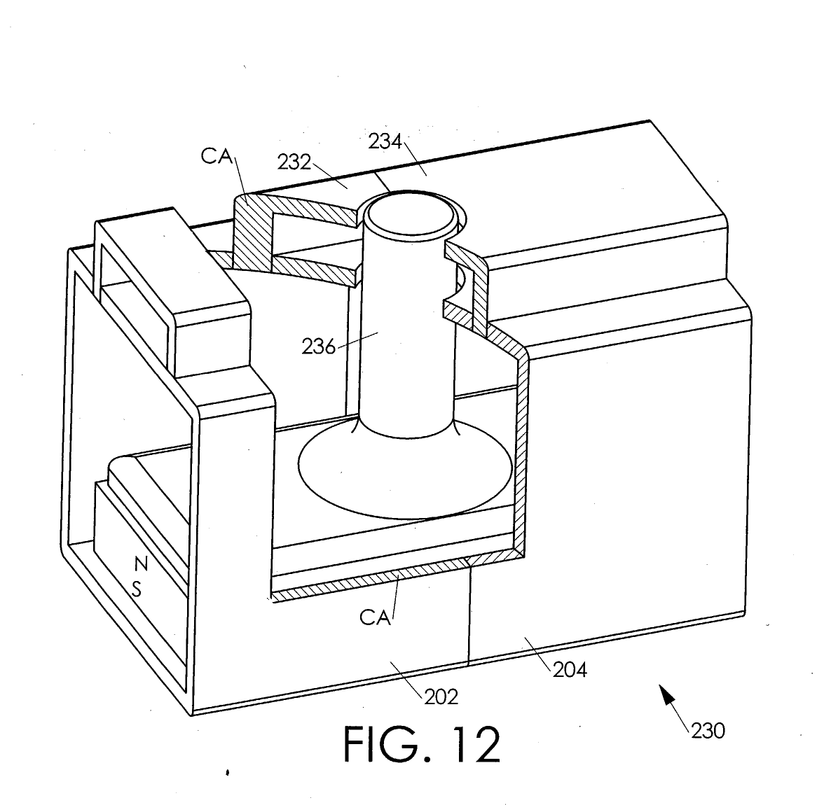

FIG. 12 illustrates another embodiment of a tube motor 230 in which the channel component 232, 234 is coupled outside the tube 202, 204. The pole piece 236 extends through the tube's hole and through the channel component's hole, to define the two magnetic air gaps. The tube motor is illustrated with a cutaway, for better visibility into its internal structures.

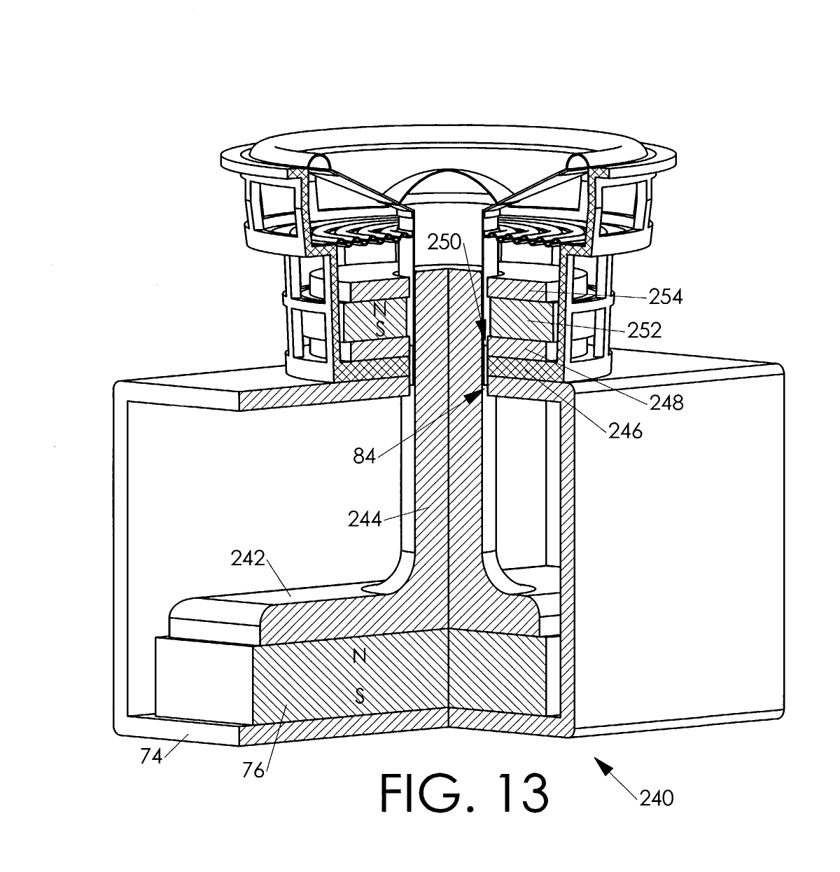

FIG. 13 illustrates yet another embodiment of a speaker 240 which advantageously utilizes principles from the present invention in conjunction with principles taught in the above-referenced co-pending applications by this inventor. The speaker includes a hybrid internal/external magnet tube geometry motor structure with a push-push dual magnetic air gap and a low reluctance return path.

The motor includes a tube 74 inside of which is magnetically coupled an internal hard magnet 76 having its magnetic polarity in a first orientation, such as with the south pole face coupled to the interior of the tube. The motor includes a pole plate 242 having an elongated pole piece 244 which extends significantly out of the air gap hole through the tube which defines a lower magnetic air gap 84. A non magnetically conductive spacer 246 is provided between the tube and a top drive plate 248. The top drive plate defines an upper magnetic air gap 250 to the pole piece. In some embodiments, such as that shown, the spacer may simply be the lower portion of the speaker basket.

An external hard magnet 252 is magnetically coupled between the top drive plate and a low reluctance return path plate 254. The external hard magnet has its magnetic polarity in the same orientation as the internal hard magnet, such as with the south pole facing the tube as shown. The magnetic flux flows in the same direction (e.g. outward) over both magnetic air gaps 84, 250. The low reluctance return path plate defines a low reluctance magnetic air gap to the pole piece. This path is not used for driving the voice coil assembly. The magnetic flux flows over the low reluctance magnetic air gap in the opposite direction as the flux over the two drive magnetic air gaps. The voice coil or voice coils may advantageously be wound about the bobbin in a same direction and positioned to extend from the middle of the lower magnetic air gap to the middle of the upper magnetic air gap. This dual gap geometry gives a tremendous increase in linear excursion of the voice coil assembly, resulting in an increased sound pressure level or perceived loudness from the diaphragm. In some embodiments, it may be desirable to balance the flux over the two drive magnetic air gaps to minimize distortion, while in others this may not be as necessary.

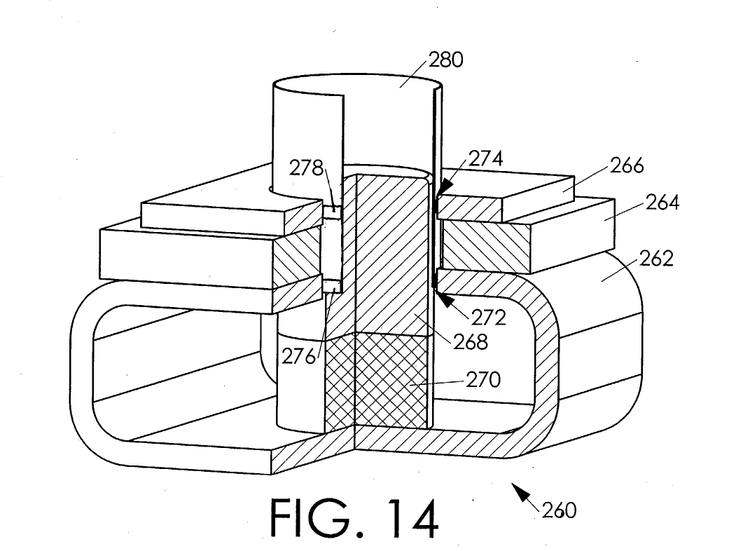

FIG. 14 illustrates a push-pull implementation of a tube geometry motor 260. The motor includes a tube 262 including an air gap hole. A hard magnet 264 is magnetically coupled between the exterior surface of the tube and a top plate 266. A pole piece 268 is disposed within the holes through the tube, magnet, and top plate, and is coupled to the tube by a non magnetically conductive spacer 270. The tube and pole piece define a lower magnetic air gap 272, and the top plate and pole piece define an upper magnetic air gap 274. A lower voice coil 276 is disposed within the lower magnetic air gap, and an upper voice coil is disposed within the upper magnetic air gap. In one magnetic pole orientation, magnetic flux from the magnet enters the top plate, crosses the upper magnetic air gap, travels down through the pole piece, crosses the lower magnetic air gap in the opposite direction, enters the tube, and returns to the magnet. The voice coils are wound in opposite directions around a bobbin 280, or are driven out of phase.

Unlike other embodiments shown, the side walls and bottom of the tube are not a significant part of the magnetic circuit in this push-pull configuration, as only the soft magnetic material of the top of the tube adjacent the magnet will play a significant part in the magnetic circuit here, as the non magnetically conductive spacer takes the side walls and bottom of the tube out of the circuit. The depth (top to bottom) of the tube serves to provide bottoming clearance for the voice coil assembly. The bottom of the tube serves as a coupling point for the spacer, which provides a coupling point for the pole piece. The bottom and side portions of the tube do not necessarily have to extend as long as the top portion and the magnet.

In a different embodiment, the magnet could be moved inside the upper wall of the tube, and the top plate could be coupled to the bottom side of the magnet, such that the push-pull magnetic circuit is inside the tube with the tube's air gap hole forming the upper magnetic air gap.

### Conclusion

The sizes of the various magnets, plates, diaphragms, voice coils, and other components are shown in the FIGS. for ease of illustration only. In practice, the skilled designer will select components of various geometries according to the needs of the application at hand. The skilled reader will further appreciate that the drawings are for illustrative purposes only, and are not scale models of optimized transducers.

“Ring-shaped” or “annular” should not necessarily be interpreted to mean “cylindrical”, but can include other shapes, such as squares, which have holes through them and are thus substantially donut-shaped. “Disc-shaped” should not necessarily be interpreted to mean “cylindrical”, but can include other shapes, such as squares, which do not have meaningful holes through them.

The skilled reader will readily appreciate that the various magnets illustrated in the drawings are shown with a particular N-S polarity orientation, and that the magnets can equally well be positioned with the opposite orientation.

The skilled reader will also appreciate that, for example, an “elongated magnet” can be formed either as a monolithic magnet having an elongated shape, or by placing multiple magnets end to end.

If the voice coil is taller (along the axis) than the magnetic air gap, the motor is said to have an “overhung” voice coil. If, on the other hand, the voice coil were shorter than the magnetic air gap, the motor is said to have an “underhung” voice coil. If the voice coil and the magnetic air gap are of equal height, the motor is said to have an “equalhung” voice coil. If the voice coil and magnetic air gap are offset in the centered or resting position, such that neither one completely overlaps the other, the voice coil may be termed “semi-hung”, such as “semi-overhung” or “semi-underhung”.

Materials may be classified as either magnetic materials or non-magnetic materials. Non-magnetic materials may also be termed non magnetically conductive materials; aluminum and chalk are examples of non-magnetic materials. Magnetic materials are classified as hard magnetic materials and soft magnetic materials. Hard magnetic materials are also called permanent magnets, and generate magnetic flux fields without outside causation. Soft magnetic materials are those which, although not permanent magnets, will themselves become magnetized in response to their being placed in a magnetic field. Soft magnetic materials include the ferrous metals such as steel and iron.

The phrase “magnetically coupled to” is intended to mean “in magnetic communication with” or in other words “in a magnetic flux circuit with”, and not “mechanically affixed to by means of magnetic attraction.” The phrase “magnetic air gap” is intended to mean “gap over which magnetic flux is concentrated” and not limited to the case where such gap is actually filled with air; the gap could, in some applications, be filled with any suitable gas or liquid, or even be under vacuum. The skilled reader will appreciate that magnetic flux may be interpreted as flowing either from the north to the south, or from the south to the north.

When one component is said to be “adjacent” another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A motor structure for an electromagnetic transducer, the motor structure comprising:
a soft magnetic tube having an exterior surface, an interior surface, and a hole extending through a side of the tube from the exterior surface to the interior surface;
a hard magnet magnetically coupled to the interior surface of the tube, the hard magnet having a pole face whose surface area is larger than the hole; and
a pole piece magnetically coupled to the hard magnet and extending through the hole to define a magnetic air gap between the pole piece and the tube.

2. The motor structure of claim 1 further comprising:
a back plate disposed between the hard magnet and the pole piece, wherein a surface of the back plate which is magnetically coupled to the hard magnet is larger than a cross-sectional area of the pole piece.

3. The motor structure of claim 2 wherein:
the back plate and the pole piece are of monolithic construction.

4. The motor structure of claim 1 wherein:
the hard magnet comprises a monolithic magnet.

5. The motor structure of claim 1 wherein:
the tube has a substantially rectangular cross-section.

6. The motor structure of claim 5 wherein:
the tube has a substantially square cross-section.

7. The motor structure of claim 1 wherein:
the tube has a length which is at least twice a width of the tube.

8. The motor structure of claim 7 wherein:
the length of the tube is at least four times the width of the tube.

9. The motor structure of claim 1 wherein:
the length of the tube is less than half the width of the tube.

10. The motor structure of claim 1 wherein:
the tube has a substantially V shape.

11. The motor structure of claim 10 further comprising:
a second hard magnet magnetically coupled between another interior surface of the tube and the pole plate.

12. The motor structure of claim 11 wherein:
the pole plate includes a wedge-shaped back plate.

13. The motor structure of claim 1 wherein:
each of the surface area of the hard magnet's pole face and the surface area of the pole plate's back face is more than twice as large as the hole.

14. The motor structure of claim 1 wherein:
each of the surface area of the hard magnet's pole face and the surface area of the pole plate's back face is more than four times as large as the hole.

15. The motor structure of claim 1 wherein:
each of the surface area of the hard magnet's pole face and the surface area of the pole plate's back face is more than eight times as large as the hole.

16. The motor structure of claim 1 wherein:
each of the surface area of the hard magnet's pole face and the surface area of the pole plate's back face is more than sixteen times as large as the hole.

17. The motor structure of claim 1 wherein:
the tube has a substantially cylindrical shape.

18. The motor structure of claim 17 wherein:
the hard magnet includes a rounded mating surface magnetically coupled to the interior surface of the cylindrical tube.

19. The motor structure of claim 1 further comprising:
a sleeve comprising soft magnetic material and magnetically coupled between the hole and the magnetic air gap.

20. The motor structure of claim 1 further comprising:
an external hard magnet magnetically coupled to the exterior surface of the tube about the hole.

21. The motor structure of claim 20 further comprising:
an external top plate magnetically coupled to the external hard magnet;
the pole piece further extending through the external top plate to define a second magnetic air gap.

22. The motor structure of claim 21 wherein:
the hard magnet and the external hard magnet have opposite magnetic polarity orientations.

23. The motor structure of claim 1 further comprising:
a second magnet magnetically coupled to a second interior surface of the tube about the hole.

24. The motor structure of claim 23 further comprising:
an internal top plate comprising soft magnetic material and magnetically coupled to the second magnet to define a second magnetic air gap with the pole piece.

25. The motor structure of claim 24 wherein:
the second magnet comprises a hard magnet; and
the hard magnet and the second magnet have a same magnetic polarity orientation.

26. The motor structure of claim 1 further comprising:
a channel component of soft magnetic material magnetically coupled to the tube and defining a second magnetic air gap between the channel component and the pole piece.

27. The motor structure of claim 26 wherein:
the channel component is disposed within the tube.

28. The motor structure of claim 26 wherein:
the channel component is disposed outside the tube.

29. The motor structure of claim 26 wherein:
the tube comprises two tubes coupled end to end; and
the channel component interlocks the two tubes.

30. The motor structure of claim 29 wherein:
the channel component is disposed within the two tubes.

31. The motor structure of claim 29 wherein:
the channel component is disposed external to the two tubes.

32. The motor structure of claim 29 wherein:
at least one of the two tubes includes a slot; and
the channel component includes a first side wall sized to butt against a wall of the tube, and a second side wall sized to extend into the slot.

33. The motor structure of claim 1 further comprising:
a spacer coupled to the exterior surface of the tube;
a top plate coupled to the spacer; and
an external hard magnet magnetically coupled to the top plate;
wherein the spacer, top plate, and external hard magnet, each includes a hole through which the pole piece extends, and wherein the hard magnet and the external hard magnet have a same magnetic pole orientation.

34. The motor structure of claim 33 further comprising:
a low reluctance return path plate magnetically coupled to the external hard magnet and including a hole through which the pole piece extends.

35. The motor structure of claim 33 wherein the spacer comprises a speaker basket.

36. The motor structure of claim 1 wherein:
the tube is of monolithic construction.

37. The motor structure of claim 1 wherein:
the hard magnet is too large to fit through the hole.

38. The motor structure of claim 1 wherein the hard magnet comprises a plurality of hard magnets disposed along an extruded axis of the tube.

39. The motor structure of claim 1 further comprising:
a diaphragm assembly coupled to the tube and including a voice coil disposed within the magnetic air gap;
wherein the motor and the diaphragm assembly together constitute an electromagnetic transducer.

40. The motor structure of claim 1 configured for use in an audio speaker.

41. The motor structure of claim 1 configured for use in a microphone.

42. The motor structure of claim 1 configured for use in a linear actuator.

43. The motor structure of claim 1 configured for use in a position sensor.

44. An electromagnetic transducer comprising:
an elongated tube including soft magnetic material and having a hole extending through from an exterior surface of the tube to an interior surface of the tube;
an elongated hard magnet magnetically coupled inside the elongated tube and having a pole surface with a surface area larger than the hole;
a pole plate including an elongated back plate magnetically coupled to the elongated hard magnet and a pole piece extending through the hole to define a magnetic air gap; and
a diaphragm assembly coupled to the elongated tube and including a voice coil disposed within the magnetic air gap.

45. The electromagnetic transducer of claim 44 wherein the elongated tube has a substantially rectangular cross-section.

46. The electromagnetic transducer of claim 44 wherein the elongated tube has a substantially v-shaped cross-section.

47. The electromagnetic transducer of claim 46 further comprising:
a second elongated hard magnet magnetically coupled between the elongated tube and the elongated back plate.

48. The electromagnetic transducer of claim 44 wherein the elongated tube has a substantially circular cross-section.

49. The electromagnetic transducer of claim 44 further comprising:
a sleeve of soft magnetic material extending through the hole and defining the magnetic air gap.

50. The electromagnetic transducer of claim 44 further comprising:
an external hard magnet magnetically coupled to the elongated tube.

51. The electromagnetic transducer of claim 50 further comprising:
an external top plate magnetically coupled to the external hard magnet;
the pole piece further extending through the external top plate to define a second magnetic air gap.

52. The electromagnetic transducer of claim 51 wherein:
the external hard magnet and the elongated hard magnet have opposite magnetic polarity orientations.

53. The electromagnetic transducer of claim 44 further comprising:
an internal hard magnet magnetically coupled to the elongated tube.

54. The electromagnetic transducer of claim 53 further comprising:
an internal top plate magnetically coupled to the internal hard magnet and defining a second magnetic air gap to the pole piece.

55. The electromagnetic transducer of claim 54 wherein:
the external hard magnet and the elongated hard magnet have a same magnetic polarity orientation.

56. The electromagnetic transducer of claim 44 further comprising:
a channel component of soft magnetic material magnetically coupled to the elongated tube and defining a second magnetic air gap between the channel component and the pole piece.

57. The electromagnetic transducer of claim 44 further comprising:
an annular spacer coupled to the exterior surface of the tube;
an annular top plate coupled to the spacer and defining an upper magnetic air gap with the pole piece; and
an external hard magnet magnetically coupled to the top plate;
wherein the voice coil is further disposed within the upper magnetic air gap.

58. The electromagnetic transducer of claim 57 further comprising:
an annular low reluctance return path plate magnetically coupled to the external hard magnet and defining a low reluctance return path with the pole piece.

59. The electromagnetic transducer of claim 57 wherein the spacer comprises a portion of a speaker basket which couples the diaphragm assembly to the elongated tube.

60. The electromagnetic transducer of claim 44 wherein:
the surface area of the elongated magnet's pole face is more than twice as large as the hole.

61. The electromagnetic transducer of claim 44 wherein:
the surface area of the elongated magnet's pole face is more than four times as large as the hole.

62. The electromagnetic transducer of claim 44 wherein:
the surface area of the elongated magnet's pole face is more than eight times as large as the hole.

63. The electromagnetic transducer of claim 44 wherein:
the surface area of the elongated magnet's pole face is more than sixteen times as large as the hole.

64. An electromagnetic transducer comprising:
a tube including an air gap hole;
at least one magnet magnetically coupled to the tube and larger than the air gap hole;
a pole piece disposed within the air gap hole and defining a first magnetic air gap between the pole piece and the tube;
a bobbin;
a first voice coil coupled to the bobbin and disposed within the first magnetic air gap; and
a diaphragm coupled to the bobbin.

65. The electromagnetic transducer of claim 64 further comprising:
a top plate magnetically coupled to the magnet, and defining a second magnetic air gap between the top plate and the pole piece; and
a second voice coil coupled to the bobbin and disposed within the second magnetic air gap;
wherein the electromagnetic transducer has a push-pull magnetic circuit.

66. The electromagnetic transducer of claim 64 wherein:
the at least one magnet is disposed inside the tube.

67. The electromagnetic transducer of claim 64 wherein:
the at least one magnet is disposed outside the tube.

68. An audio speaker comprising:
an elongated tube having a hole extending through a side of the tube from an exterior surface of the tube to an interior surface of the tube;
an elongated hard magnet magnetically coupled inside the elongated tube and having a pole face whose surface area is larger than the hole; and
an elongated pole plate magnetically coupled to the elongated hard magnet inside the elongated tube and extending through the hole to define a magnetic air gap in a magnetic circuit from the elongated hard magnet through the elongated pole plate, over the magnetic air gap, through the elongated tube, and back to the elongated hard magnet;
a basket coupled to the elongated tube;
a diaphragm suspended from the basket;
a bobbin coupled to the diaphragm and suspended from the basket;
a voice coil coupled to the bobbin and disposed within the magnetic air gap;
wherein the elongated tube is longer than,
the elongated tube is wide, and
the elongated tube is deep.

69. The electromagnetic transducer of claim 68 wherein the elongated tube is also longer than the basket is wide.
